(19) United States
(12) Patent Application Publication
(10) Pub. No.: US 2011/0281538 A1
(43) Pub. Date: Nov. 17, 2011

(54) Personalized Media Recommendations

(75) Inventors: Andrew R. Morrison, Bellevue, WA (US); Christopher S. Park, Bellevue, WA (US)

(73) Assignee: T-MOBILE USA, INC., Bellevue, WA (US)

(21) Appl. No.: 12/779,876

(22) Filed: May 13, 2010

(51) Int. Cl. G06N 5/02; G06F 15/18; G06F 17/00; H04B 1/18

(52) U.S. Cl. 455/185.1; 706/12; 706/54; 700/94

(57) ABSTRACT

Techniques for recommending over-the-air radio stations and other streaming media to a user are described herein.

### BACKGROUND

In the last few years mobile devices such as cellular phones, landline phones and IP-based phones have become more and more capable, offering an increasing array of functions. Once limited to simple point-to-point voice communications, telecommunications devices have evolved into so-called “smart phones” that offer many different modes of telecommunication, such as voice, video, text messaging, instant messaging, email, and other modes of communication.

Media playback is a popular use of mobile devices, including telecommunications devices. Music and video, in particular, are widely distributed in digital form and consumed using portable media players. Media items or selections such as individual songs or videos can be purchased and stored on small, portable devices and played back at will without advertising or other interruptions, allowing a user to play only those selections in which he or she is interested. Similarly, some types of media can be streamed using wireless data communications capabilities and played as it is being streamed.

Some modern media devices also incorporate traditional terrestrial, over-the-air radio receivers, such as tunable AM, FM and television receivers. Receivers such as this typically receive and render broadcasts. A broadcast is an information and entertainment stream that is transmitted in common to multiple receivers. When consuming a particular broadcast, each receiver receives the same content or programming, which is defined by a broadcast programmer Typical listeners or viewers have no choice or selection capability regarding the streamed content, other than initially selecting one of multiple broadcasts: all consumers of a particular broadcast receive the same information.

Although terrestrial broadcasts have advantages, such as local and more varied content, one drawback of traditional over-the-air broadcasting is the difficulty users face when trying to find a particular channel or broadcast in which they might be interested. Generally, broadcast receivers are tuned by frequency. A user scans available frequencies to discover channels. In some cases, receivers might display the name or call sign of a channel. However, it is usually necessary to listen to the channel for awhile to determine what type of music or content it plays. A user looking for jazz music, for example, must normally scan through frequencies until he or she hears actual jazz content. This can be a frustrating exercise, especially since broadcasts are frequently interrupted by commercials and other distractions.

The difficulty of finding appropriate over-the-air stations is further complicated by people's increasingly mobile lifestyles, in which they might find themselves in several different cities in a single day or week. Although users tend to memorize available stations in their home area, this is not very practical when frequently traveling to different locations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a block diagram illustrating an exemplary system and environment in which the concepts described herein may be implemented.

FIG. 2 is a simplified view of an example user interface for use with a mobile device.

FIG. 3 is a flowchart showing an example of recommending local broadcast stations or other streaming content to a user.

FIG. 4 is a simplified view of another example user interface for use with a mobile device.

FIG. 5 is a block diagram showing an example of how a media device might be implemented for use in conjunction with the concepts and techniques described herein.

### DETAILED DESCRIPTION

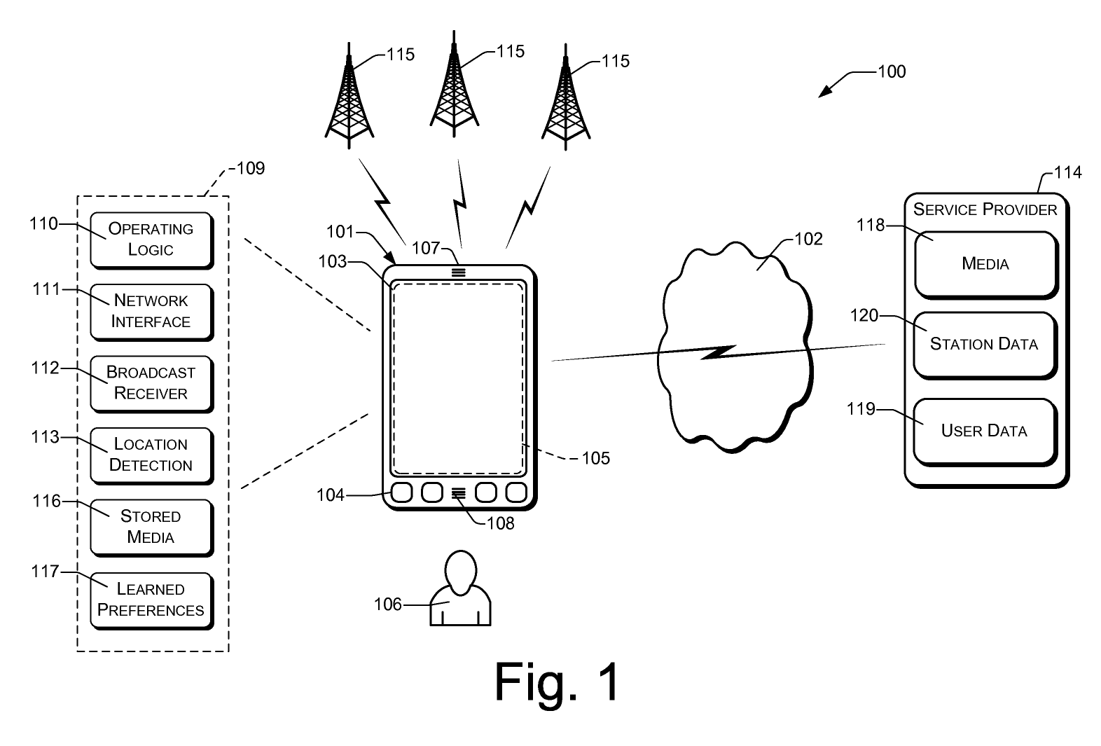

FIG. 1 illustrates an exemplary operational environment 100 in which the techniques described below can be implemented. The environment 100 includes a mobile device 101. Mobile device 101 can be a personal media player device or other portable device capable of playing digital media such as music and video. For example, mobile device 101 can be a telecommunications device such as a mobile cellular telephone, a personal digital assistant, a smart phone, an Internet Protocol (IP) or Voice-Over-IP (VOIP) phone, a reader device, a video player, a music player, or other portable device. In the particular embodiment described herein, mobile device 101 is capable of connecting to one or more data and/or voice networks, as represented by network 102.

Network 102 is representative of any one or combination of multiple different types of networks, interconnected with each other and functioning as a single large network (e.g., circuit-switched telephone networks or IP-based packet-switch networks). Network 102 may also include wire-based networks (e.g., cable) and wireless networks (e.g., cellular, satellite, etc.). In the case of wireless networks, network 102 may be accessed by mobile device 101 for receiving and transmitting wireless signals. Network 102 may use any number of protocols and configurations to enable the mobile device 101 to access other devices and resources. Network 102 may include several types of circuit-switched telephone networks, such as Public Switched Telephone Network (PSTN) and packet-switched networks, such as the Internet. For example, network 102 may include Global System for Mobile communication (GSM)/UMTS cellular network, a Code Division Multiple Access (CDMA) cellular network, other types of circuit-switched networks and/or the Internet. Network 102 may also include private networks such as mobile telephone operators' networks, which may use proprietary systems or protocols that are different from the systems or protocols implemented on public networks.

Mobile device 101 may include a display 103 and keys or buttons 104, forming a user interface (UI) 105 that allows a user 106 to configure and operate mobile device 101. In this example, display 103 is a flat-panel display having a touch-sensitive surface. Using this type of display, the UI of mobile device 101 can include displayed or “soft” buttons and controls that are responsive to user touch.

Mobile device 101 also includes one or more speakers 107 through which audio media can be rendered. Headphones might be used in many embodiments in place of or in addition to speakers 107. Video media can be rendered on display 103, along with accompanying audio through speakers 107.

Mobile device 101 may also include a microphone 108, especially in embodiments in which mobile device 101 is a voice communications device. For example, embodiments in which mobile device 101 is a telephonic device are likely to include microphone 108.

Mobile device 101 includes internal operational components, of which some of the most relevant are represented symbolically in FIG. 1 within dashed box 109. Internal operational components include operational logic 110, a network interface 111, a broadcast receiver 112, and location detection functionality 113. Particular components used within mobile device 101 will of course vary depending on implementation choices.

Operational logic 110 is responsible for UI 105 of device 101 as well as for coordinating and supervising various other components within mobile device 101, and to perform the functions and provide the operational characteristics described below.

Network interface 111 can comprise one or more wireless bi-directional data interfaces, such as Wi-Fi interfaces, cellular data interfaces, and/or other types of wireless data and voice communications interfaces. Network interface 111 provides network connectivity through network 102 to one or more service providers such as an illustrated service provider 114. In many embodiments, network 102 may provide connectivity to the public Internet, through which multiple service providers can be accessed in addition to service provider 114.

Broadcast receiver 112 in this embodiment is a tunable FM radio receiver that can be tuned to different frequencies to receive over-the-air terrestrial broadcasts from local radio stations, which are represented in FIG. 1 as broadcast towers 115. Generally, the availability of over-the-air radio broadcasts varies by geographic location, because particular terrestrial broadcast stations have limited geographic coverage. In any particular location, there may be a plurality of available broadcast stations or channels that can be received with varying degrees of signal strength.

Other types of frequency-tunable receivers might be used in place of or in addition to the illustrated FM receiver, including tunable television receivers, AM receivers and shortwave receivers. Furthermore, streamable media, of which radio transmissions are an example, is not limited to radio channels. A vast variety of streamable media is available from network 102 and associated Internet sources, including media that have specific geographic relevance. Radio channels themselves can often be accessed and received in real time from a data network or provider through network interface 111.

Location detection functionality 113 might be embodied as a Global Positioning Satellite (GPS) receiver that is responsive to satellite and/or other wireless transmissions to determine the exact or approximate geographical location of mobile device 101. Alternatively, location detection functionality 113 might be embodied in different ways. For example, geographic location might be determined by identifying received wireless signals, such as Wi-Fi signals or cellular network signals, and comparing those signals to databases that map known signals to specific or approximate geographic locations. As yet another alternative, a user might be asked to manually specify his or her location, such as by manually entering a zip code. In scenarios where mobile device 101 is a cell phone, it may be connected to a cellular communications network that explicitly identifies the general operating location of mobile device 101, or that identifies the cell site ID (CGI) being used by the cell phone.

In the illustrated embodiment, mobile device 101 also comprises stored media 116. Stored media 116 comprises digital objects or files that can be rendered to play audio, video, or other types of media items. These objects or files might be stored in different formats, including compressed formats and formats that limit usage to authorized devices and users. Stored media 116 typically resides in non-volatile device memory within mobile device 101, or in some type of removable media that can be accessed by mobile device 101.

Learned user media preferences 117 comprise data that indicate characteristics of media items that the user likes or in which the user has demonstrated an interest. Many different methods can be used to learn user media preferences at various levels of specificity. Many of these methods are based upon an examination and analysis of media that the user owns or has already selected, purchased, downloaded, or played. Characteristics of such historical media are analyzed to determine characteristics that the user prefers. Additional media can then be suggested based on these determined or learned preferences. Preferences might also be learned based on indications or ratings by a user, such as a number of “stars” awarded by the user, or by the user explicitly indicating “likes” or “dislikes” for particular items.

Service provider 114 can be an Internet-based provider or website or some type of proprietary and limited-access network-accessible server available only to subscribers of a proprietary or private network. Although only a single service provider 114 is shown in FIG. 1, the illustrated content and functionality can be provided by a number of different providers.

Among other services, service provider 114 can store and provide media 118, user data 119, and station data 120. Media 118 may comprise audio, video, and other types of media. Media 118 is often available as discrete selections or items, such as individual songs, videos, movies, or other works. Media 118 can generally be downloaded to media device 101 and stored for later rendering, or it can be streamed and rendered as it is received. Streamed media might include streaming versions of radio and television channels or stations, including channels that originate from particular geographic locations and/or have particular relevance to specific geographic locations.

Various different services are available from which media can be downloaded and/or streamed. Many such services charge fees for different types of media access. For example, some services might charge for each downloaded selection. Other services might charge on a subscription basis for downloading and streaming Similarly, different types of access and usage rights might be granted by different services. Some services grant rights to a particular work for an unlimited time, which is similar to “owning” a copy of that work. Other services might grant rights only during the period of an active subscription, which is similar to a limited-time “license.” Furthermore, some services or subscriptions allow downloading and local storage of selections or works, while other services only allow streaming without local storage. Except in the case of public domain works, usage rights are usually enforced using cryptography and encryption techniques, referred to as Digital Rights Management (DRM).

Operating logic 110 is configured to communicate through network interface 111 with one or more service providers 114 to download and/or stream media 118 for local rendering. In addition, operating logic 110 is configured to tune radio receiver 112 to local broadcast channels and to play one of the broadcast channels selected by a user. UI 105 of mobile device 101 allows user 106 to select particular streaming sources, media selections or broadcast channels to be played at any given time.

Service provider 114 can also store user data 119. User data 119 can indicate various subscription and/or payment related information about user 106, and additionally can indicate user media preferences. For example, mobile device 101 can provide its learned user preferences 117 to service provider 114. Alternatively, the user preferences might be learned by service provider 114 based on previous media provided to mobile device 101 from service provider 114 for local use and/or storage.

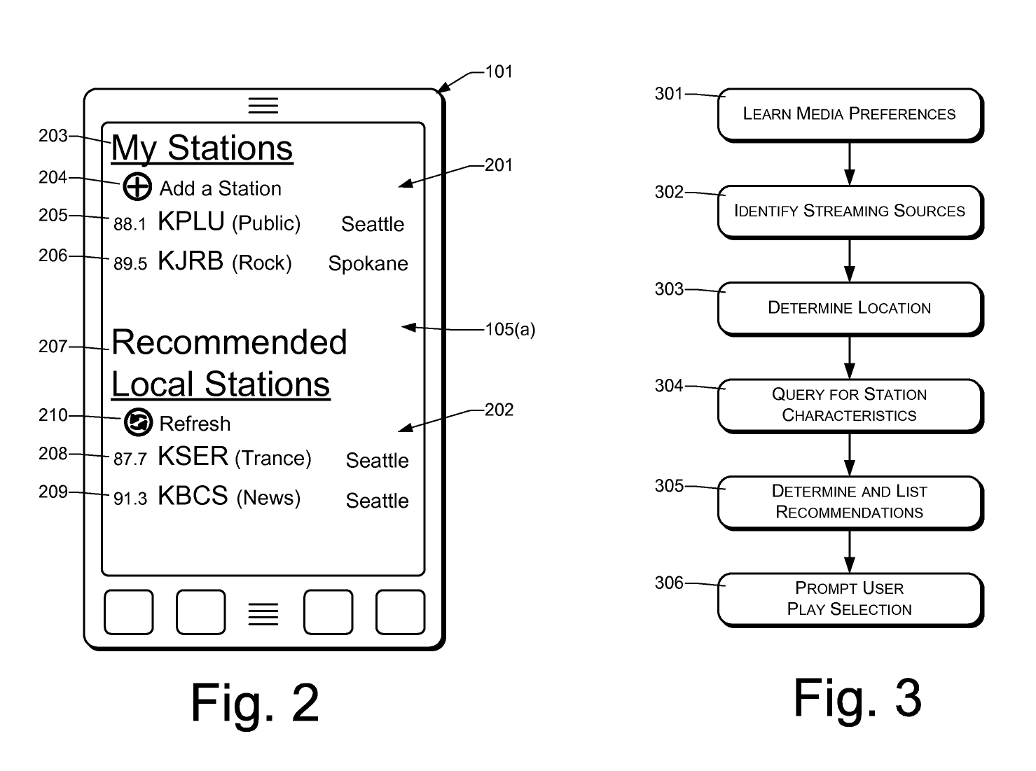

FIG. 2 shows an example UI 105(a) through which a user may select and listen to radio stations using media device 101. The elements shown in FIG. 2 (and subsequent UI illustrations) are those most relevant to the discussion herein, and may in practice be used in conjunction with other elements and enhancements, depending on the particular embodiment.

UI 105(a) includes two sections: an upper “favorites” section 201 and a lower “recommendations” or “suggestions” section 202. Favorites section 201 includes a heading 203, which in this example is “My Stations.” This section lists streaming media sources such as over-the-air radio stations that the user has indicated as being favorites or most frequently accessed. A particular station can be added to favorites section 201 by pressing an icon 204, which is labeled “Add a Station.” When a station has been added, it is identified beneath heading 203 by its radio frequency and its name or call sign. For example, UI 105(a) includes a first favorite station 205 and a second favorite station 206. First favorite station 205 is identified by its frequency, “88.1”, and by its call sign, “KPLU.” Second favorite station 206 is identified by its frequency, “89.5,” and by its call sign, “KJRB.”

In addition, favorites section 201 can indicate content type or genre for each station, and the geographical location of each station. In this example, first favorite station 205 identifies its content type or genre as “Public” and its geographic location as “Seattle.” Second favorite station 206 identifies its content type or genre as “Rock” and its geographic location as “Spokane.”

Recommendations section 202 includes a heading 207, which in this example is “Recommended Local Stations.” This section lists over-the-air radio stations that can currently be received and that the user may prefer based on learned preferences 117.

Available and recommended stations are listed following heading 207 in a manner similar to the identification of stations in favorites section 201: by frequency, name or call sign, content type or genre, and geographic location. In this example, the recommended stations include a first recommended station 208 and a second recommended station 209. First recommended station 208 is identified by its frequency, “87.7,” and by its call sign, “KSER.” Second recommended station 209 is identified by its frequency, “91.3,” and by its call sign, “KBCS.” In addition, recommendations section 202 can indicate content type or genre and geographical location of each station. In this example, first recommended station 208 has an identified content type or genre of “Trance” and its geographic location is “Seattle.” Second recommended station 209 has an identified content type or genre of “News,” while its geographic location is “Seattle.”

Recommendations section 202 also includes an icon 210 that can be tapped or selected to refresh the recommended stations in accordance with the current location of media device 101. Generally, refreshing the list causes media device 101 to identify stations that can currently be received and that match the user's learned preferences.

FIG. 3 shows an example of how recommendations section 202 might be generated. In this example, an action 301 comprises learning media preferences of the user of portable media device 101. In some embodiments, this action is based on a history of individual and/or discrete non-streaming media items previously stored and/or played by the user on media device 101, and is performed during normal usage of media device 101 by recording or logging a history of individual and/or discrete media items previously stored and/or played by the user on media device 101. Alternatively, rather than logging the media items themselves, media device 101 might log characteristics of the media items. For example, media device 101 might record statistics regarding the genres of songs played on media device 101. As another example, media device 101 might record tags associated with songs played on media device 101. Note that in the examples described herein, the user media preferences are learned based on previous usage, purchase, download, selection, etc. of individual and/or discrete items or works such as individual songs, albums, or videos, as opposed to previous stream, program, or channel selections that the user might have made. In some embodiments, user media preferences are based on individual media items that the user has actually consumed on media device 101. In other embodiments, user media preferences are based on individual media items that are physically stored on media device 101 or storage components associated with media device 101.

User preferences might also be learned in other ways. As one simple example, media preferences may be learned by simply prompting the user for his or her preferences, such as by asking a user to indicate which of a plurality of genres the user prefers. As another example, a user may rate general content categories or individual items, such as by awarding them “stars” or simply indicating “like” or “dislike” with respect to individual items or streams. In some embodiments, learning preferences may take place at discrete times, rather than during normal usage of device 101, and may be based on things other than general usage history. For example, certain activities, such as initiating a playlist, might trigger an action of examining media items of the playlist itself to determine user media preferences. As another example, mobile device 101 might query an online data source such as service provider 114 to obtain user media preferences for a particular user.

User media preferences might be learned by media device 101 or by one or more service providers from which individual media items are obtained. Similarly, the media preferences might be stored locally on device 101, remotely on a service provider such as service provider 114, or on both. When stored remotely, media device 101 can retrieve the user media preferences from the remote source as needed, using the networking capabilities of network interface 111.

When a user taps or selects icon 210, requesting media device 101 to refresh its station recommendations, an action 302 is performed, comprising identifying one or more streaming sources that are currently available to the portable media device. In the described embodiment, this involves scanning radio receiver 112 to identify or detect over-the-air radio stations or channels that are available and receivable by media device 101 at its current location. In some embodiments, this may involve tuning receiver 112 to each of a plurality of possible frequencies, recording the signal strength of any station received at each frequency, and selecting those channels having relatively higher signal strengths. From this, media device 101 identifies those frequencies with the highest signal strengths, or those frequencies having signal strengths that exceed a predetermined threshold. These frequencies are then assumed to correspond to available over-the-air stations.

An action 303 comprises determining the current geographic location of media device 101. In the described embodiment, this is performed in conjunction with location detection components 113. As already described, this may involve a GPS receiver or some other type of automatic location determination techniques. In other cases, the user may simply be prompted to enter a zip code or other information indicating geographic location.

An action 304 comprises querying a data source to obtain characteristics and descriptive information regarding the media sources identified as being available in action 302. The data source may be stored within media device 101, or may be located remotely; such as the station data 120 of service provider 114. When the data source is remote, this query is communicated to service provider 114 using wireless network interface 111 and network 102. In one embodiment, the query includes submission of channel parameters comprising (a) frequencies of the available radio channels; and (b) the current geographic location of media device 101. In response media device 101 receives descriptive information corresponding to each available channel from remote service provider 114. The descriptive information may include station name, call sign, broadcast frequency, content type, genre, geographical location name (such as the city from which the station originates), descriptive or user-generated tags, and so forth.

In other embodiments, action 304 might comprise obtaining descriptive information about available media sources from broadcast data accompanying the media sources, such as Radio Data System (RDS) or Radio Broadcast Data System (RBDS) data. RDS and RBDS are similar standards allowing over-the-air broadcasts to contain small amounts of digital information. In some situations, this information may relate to station programming, allowing media device 101 to determining descriptive information about certain available broadcast channels.

An action 305 comprises determining and listing recommendations of available radio stations based on the learned media preferences. Such recommendations include one or more of the identified radio stations whose content matches or is similar to the user media preferences. This action includes comparing the channel descriptive information received in action 304 with the learned media preferences of action 301.

An action 306 comprises prompting the user of media device 101 to select a desired one of the listed recommendations, such as by presenting a menu of the recommended radio stations on user interface 105—in this example as part of recommendations section 202. Action 306 further comprises receiving a selection from the device user via user interface 105 of a particular one of the recommended radio channels, and tuning the radio receiver to the selected channel to play the selected one of the listed or recommended radio stations in response to user selection of that station from UI 105.

Referring again to FIG. 2, a user can select one of the recommended local stations in section 202 by tapping it or using any other available UI mechanism. When selected, media device 101 responds by tuning its receiver 112 to the selected station, and playing that station on speaker 107.

In addition to selecting and playing a recommended radio station, different stations can be added to the favorites section 201 by selecting or tapping icon 204. In response, media device 101 presents appropriate UI elements allowing the user to specify an additional station to be displayed in favorites section 201. Stations can be added manually, by specifying frequency and other information. Alternatively, a user can select from a list of available and recommended stations.

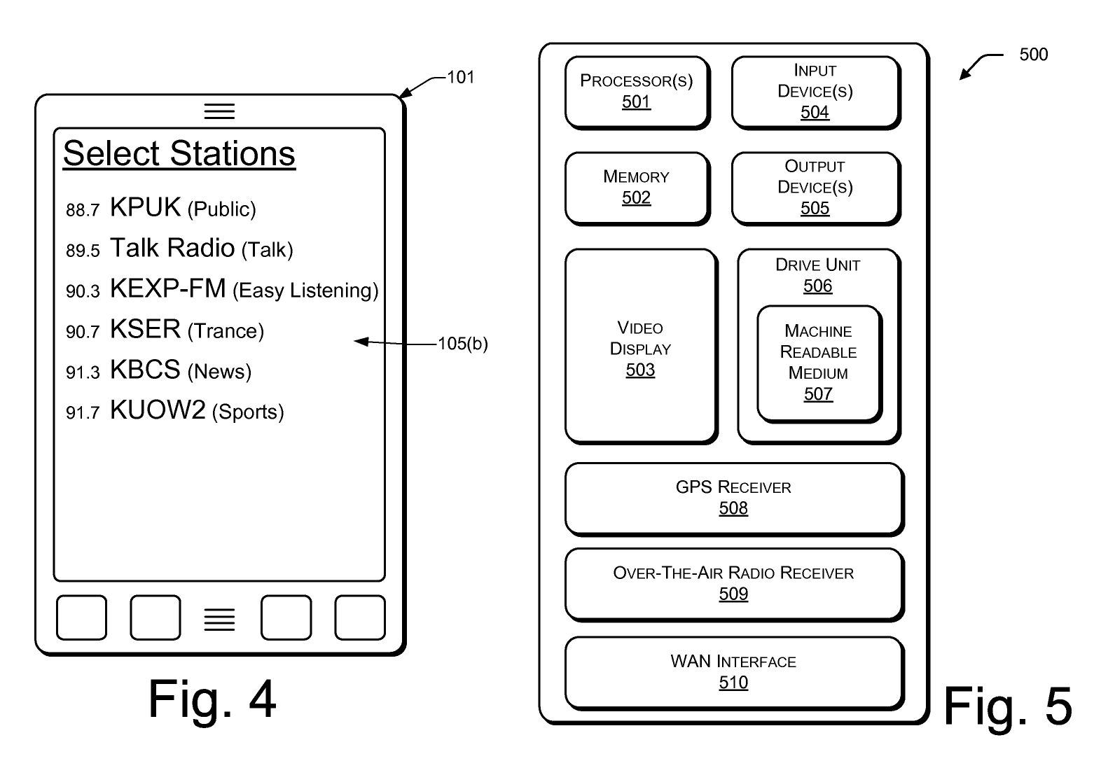

FIG. 4 shows a UI 105(b) that may be generated by mobile device 101 in response to pressing icon 204 to add a station to favorites section 201. UI 105(b) comprises a list of recommended stations, formulated in accordance with the procedure described with reference to FIG. 3. The user can select one or more of the identified stations and those stations will subsequently be added to favorites section 201.

FIG. 5 shows an exemplary mobile device 500 such as may be used as media device 101. Mobile device 500 comprises one or more processors 501, a memory 502, a video display 503, one or more input devices 504, one or more output devices 505, a drive unit 506 that can access a computer or machine readable medium 507, a GPS receiver 508, an over-the-air radio receiver 509, and a WAN port or interface 510.

Machine readable medium 507 stores one or more sets of instructions (e.g., software) embodying any one or more of the methodologies or functions described above, including operation logic 110. The instructions may also reside, completely or at least partially, within memory 502 and within processor 501 during execution thereof by mobile device 500. Furthermore, the instructions may be embodied as one or more programs that are distributed to users on some type of computer or machine readable media.

For example, the machine-readable memory might include an operating system or other program configured to perform the actions described above with reference to the preceding figures. In some cases, a program for achieving the functionality described above might be loaded onto mobile device 500 by a reseller of the device, such as by a service carrier that bundles the device with a service plan. In other cases, the manufacturer of the device might include the functionality as a native element of the device. Alternatively, the functionality might be part of a program that is installed by an end-user.

Input devices 504 may comprise a keyboard, keypad, touch screen, or microtelecommunications device. Other input devices 504 may be used. Video display 503 may be a liquid crystal display (LCD), a flat panel, a solid state display or other device. Processor 501 may be a central processing unit (CPU), a graphics processing unit (GPU), or both CPU and GPU, or other processing unit or component.

GPS receiver 508, over-the-air radio receiver 509, and WAN interface 510 can be implemented in various ways, using different technologies. Over-the-air radio receiver 509 can be an FM receiver or can be a receiver that works with other radio frequencies and/or modulation techniques. WAN interface 510 can be a cellular data interface, using any of numerous cellular technologies. Alternatively, or in addition, WAN interface 510 might comprise a Wi-Fi network interface, or some other type of wireless data or networking interface.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

Further, it should be noted that the system configurations illustrated above are purely exemplary of systems in which the implementations may be provided, and the implementations are not limited to the particular hardware configurations illustrated. In the description, numerous details are set forth for purposes of explanation in order to provide a thorough understanding of the disclosure. However, it will be apparent to one skilled in the art that not all of these specific details are required.

We claim:

1. A method comprising:
obtaining media preferences of a user of a portable media device based on a history of individual media items previously selected by the user;
identifying one or more streaming media sources currently available to the portable media device, the one or more streaming media sources being identified based on geographic location of the portable media device;
recommending one or more of the identified streaming media sources to the user based on the media preferences; and
playing one of the recommended streaming media sources selected by the user.

2. A method as recited in claim 1, wherein the obtaining comprises learning the media preferences from a history of individual media items previously played by the user.

3. A method as recited in claim 1, wherein the identifying comprises scanning radio frequencies for available media sources.

4. A method as recited in claim 1, further comprising:
obtaining descriptive information regarding the identified streaming media sources; and
comparing the descriptive information with the obtained media preferences.

5. A method as recited in claim 1, further comprising:
querying an online data source to obtain descriptive information regarding the identified streaming media sources; and
comparing the descriptive information with the obtained media preferences.

6. A method as recited in claim 1, wherein the identifying comprises scanning radio frequencies for available media sources, the method further comprising:
obtaining descriptive information regarding the available media sources based on (a) the frequencies of the available media sources and (b) the current geographic location of the portable media device; and
comparing the descriptive information with the obtained media preferences.

7. A method comprising:
identifying over-the-air radio channels receivable by a portable media device at its current geographic location; and
recommending one or more of the identified over-the-air radio channels based on media preferences learned from a history of individual media items previously selected by a user of the portable media device.

8. A method as recited in claim 7, wherein the identifying comprises scanning radio frequencies.

9. A method as recited in claim 7, further comprising:
prompting the user of the portable media device to select one of the identified over-the-air radio channels; and
playing the selected over-the-air radio channel to the user.

10. A method as recited in claim 7, further comprising:
obtaining descriptive information regarding the identified over-the-air radio channels; and
comparing the descriptive information with the media preferences.

11. A method as recited in claim 7, further comprising:
querying an online data source to obtain descriptive information regarding the identified over-the-air radio channels; and
comparing the descriptive information with the media preferences.

12. A method as recited in claim 7, further comprising:
obtaining descriptive information regarding the identified over-the-air radio channels based on (a) the frequencies of the identified over-the-air radio channels and (b) the current geographic location of the portable media device; and
comparing the descriptive information with the media preferences.

13. A method as recited in claim 7, further comprising:
learning the media preferences based on a history of media previously played by the user.

14. A telecommunications device comprising:
a broadcast receiver that is tunable to receive over-the-air broadcasts on different channels depending on geographic location;
a user interface;
device operational logic configured to:
scan the broadcast receiver to detect channels receivable by the telecommunications device at its current geographic location;
select one or more of the detected over-the-air broadcast channels based on learned media preferences of a device user, the learned media preferences being based on a history of individual media items previously selected by the user;
present a menu of the selected over-the-air broadcast channels to the device user via the user interface;
receive a selection from the device user via the user interface of a particular one of the selected over-the-air broadcast channels; and
tune the broadcast receiver to the particular one of the selected over-the-air broadcast channels.

15. A telecommunications device as recited in claim 14, further comprising a wireless network interface, the device operational logic being further configured to:
obtain descriptive information regarding the detected over-the-air broadcast channels from a remote source using the wireless network interface; and
compare the descriptive information with the learned media preferences to select the one or more of the detected over-the-air broadcast channels.

16. A telecommunications device as recited in claim 14, further comprising a wireless network interface, the device operational logic being further configured to:
determine the current geographic location of the telecommunications device;
submit channel parameters to a remote source using the wireless network interface, the channel parameters comprising (a) frequencies of the detected over-the-air broadcast channels and (b) the current geographic location of the telecommunications device; and
receiving channel descriptive information from the remote source in response to submitting the channel parameters.

17. A telecommunications device as recited in claim 14, the device operational logic being further configured to learn the learned media preferences based on a history of media previously played by the device user.

18. A telecommunications device as recited in claim 14, the device operational logic being further configured to obtain the learned media preferences from a remote source.

19. A telecommunications device as recited in claim 14, further comprising a wireless network interface, the device operational logic being further configured to obtain the learned preferences from a remote source using the wireless network interface.

20. One or more computer-readable storage media having stored thereon instructions that are executable by a telecommunications device to perform actions comprising:
determining the current geographic location of the telecommunications device;
identifying over-the-air broadcast channels that can be received at the current geographic location;
obtaining learned preferences that are based on a history of individual media items previously selected by a user of the telecommunications device;
presenting a recommended channel list identifying one or more of the identified over-the-air broadcast channels that correspond to the learned preferences;
receiving a selection from a device user of a desired channel from the recommended channel list; and
playing the desired channel.

21. One or more computer-readable storage media as recited in claim 20, the actions further comprising:
obtaining channel descriptive information regarding the identified over-the-air broadcast channels;
comparing the channel descriptive information with learned preferences to form the recommended channel list.

22. One or more computer-readable storage media as recited in claim 20, the actions further comprising:
obtaining channel descriptive information regarding the identified over-the-air broadcast channels from a remote source;
obtaining user media preferences from a remote source; and
comparing the channel descriptive information with the learned preferences to form the recommended channel list.

23. One or more computer-readable storage media as recited in claim 20, the actions further comprising:
obtaining channel descriptive information regarding the identified over-the-air broadcast channels from a remote source based on (a) the frequencies of the identified over-the-air broadcast channels, and (b) the current geographic location of the portable media device.

24. One or more computer-readable storage media as recited in claim 20, wherein identifying the over-the-air broadcast channels comprises scanning broadcast frequencies.
